(19) United States
(12) Patent Application Publication
(10) Pub. No.: US 2017/0253706 A1
(43) Pub. Date: Sep. 7, 2017

(54) Hard Coating Film

(71) Applicant: Dongwoo Fine-Chem Co., Ltd., Seoul (KR)

(72) Inventors: Geo San Lim, Seoul (KR); Dong Hwi Kim, Seiong-si (KR); Seung Hee Kim, Seoul (KR)

(21) Appl. No.: 15/448,407

(22) Filed: Mar. 2, 2017

(30) Foreign Application Priority Data
Mar. 4, 2016 (KR) 10-2016-0026369
Feb. 1, 2017 (KR) 10-2017-0023027

(51) Int. Cl. C08J 7/04

(52) U.S. Cl. CPC C08J 7/042; C08J 2379/08; C08J 2435/02

(57) ABSTRACT

A hard coating film according to the present invention includes a transparent substrate layer; a first hard coating layer which is formed of a cured product of a hard coating composition including a high elongation oligomer having an elastic modulus ranging from 10 to 3000 MPa and an elongation at break ranging from 30 to 150% on one surface of the transparent substrate layer; and a second hard coating layer which is formed on a top surface of the first hard coating layer and has a Martens hardness ranging from 350 to 1000 N/mm² and a compressive elastic modulus ranging from 4000 to 10000 MPa.

### BACKGROUND

1. Technical Field

The present invention relates to a hard coating film which exhibits excellent impact resistance, bending resistance and scratch resistance, and can minimize the occurrence of a curl.

2. Description of the Related Art

As mobile devices such as smart phones, tablet PCs have been developed in recent years, thinner and slimmer display substrates have been required. Glass or tempered glass as a material having excellent mechanical properties has been generally used for a display window or a front plate of these mobile devices. However, the glass causes a weight of the mobile devices to be heavy due to its own weight, and has a problem of damage due to an external impact.

Therefore, plastic resins are being studied as a substitute for glass. A plastic resin composition is appropriate for the trend of pursuing a lighter mobile device because it is lightweight and is less likely to be broken. In particular, a composition in which a supporting substrate is coated with a hard coating layer has been proposed to achieve a composition having high-hardness and wear resistance.

As a method of improving surface hardness of a hard coating layer, a method in which the thickness of a hard coating layer increases can be considered. In order to ensure enough surface hardness to substitute for glass, it is necessary to realize a constant thickness of a hard coating layer.

As the thickness of a hard coating layer increases, surface hardness may increase. However, wrinkling or curling increases due to cure shrinkage of a hard coating layer and simultaneously a hard coating layer is likely to be cracked or peeled off. Therefore, it is not easy to practically apply the method.

Recently, several methods for realizing high-hardness of a hard coating film and simultaneously solving a problem of cracking of a hard coating layer or a curl caused by cure shrinkage have been proposed.

Korean Patent No. 10-1415838 relates to a hard coating composition, which includes a mono- to hexa-functional acrylate monomer; a photocurable elastomer having an elongation ranging from 15 to 200% measured by ASTM D638; a photoinitiator; and an organic solvent. However, the hard coating composition is applied to only one hard coating layer, the hard coating layer thus produced does not exhibit enough bending property and impact resistance to substitute for a glass panel of a display, and poor scratch resistance of a surface is also exhibited.

In addition, Korean Patent No. 10-1234851 relates to a hard coating composition and a laminate including a hard coating layer. The hard coating composition includes an alkylene-glycol-based acrylic monomer, a multifunctional acrylic monomer and a polymerization initiator, wherein the alkylene-glycol-based acrylic monomer is included at 5 to 80 wt % with respect to the total solid content amount of the composition. However, the hard coating composition disclosed above is also applied to only one hard coating layer, the hard coating layer thus produced does not exhibit enough bending property and impact resistance to substitute for a glass panel of a display, and poor scratch resistance of a surface is also exhibited.

### PRIOR-ART DOCUMENTS

### Patent Documents

Korean Patent No. 10-1415838 (Jun. 30, 2014; LG Chem Ltd.)

Korean Patent No. 10-1234851 (Feb. 13, 2013; Cheil Industries Inc.)

### SUMMARY

The present invention is designed to solve the problems of the prior art, and it is an object of the present invention to provide a hard coating film which exhibits excellent impact resistance, bending resistance and scratch resistance, and can minimize the occurrence of a curl.

In order to accomplish the above object, a hard coating film according to the present invention includes a transparent substrate layer; a first hard coating layer formed of a cured product of a hard coating composition including a high elongation oligomer having an elastic modulus ranging from 10 to 3000 MPa and an elongation at break ranging from 30 to 150% on one surface of the transparent substrate layer; and a second hard coating layer formed on a top surface of the first hard coating layer and having a Martens hardness of 350 N/mm² or more and a compressive elastic modulus of 4000 MPa or more.

As described above, a hard coating film according to the present invention includes a first hard coating layer including a high elongation oligomer having an elastic modulus and elongation at break in a specific range and a second hard coating layer having a Martens hardness and compressive elastic modulus in a specific range, and thus excellent impact resistance, bending resistance and scratch resistance are exhibited and can minimize the occurrence of a curl caused by cure shrinkage of a hard coating film.

### BRIEF DESCRIPTION OF DRAWINGS

FIG. 1 illustrates a hard coating film according to the present invention.

### DETAILED DESCRIPTION OF EMBODIMENTS

Hereinafter, the present invention will be described in detail with reference to exemplary embodiments.

<Hard Coating Film>

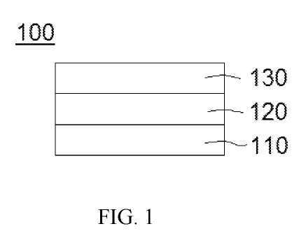

A hard coating film 100 according to the present invention includes a transparent substrate layer 110, a first hard coating layer 120 and a second hard coating layer 130, all of which are sequentially laminated, as shown in FIG. 1. This will be described below in more detail.

Transparent Substrate Layer

The hard coating composition to be described below is applied on at least one surface of the transparent substrate layer 110 and then cured to form the hard coating film 100.

The term “transparent” used herein means that the transmittance of visible rays is 70% or more or 80% or more.

The transparent substrate layer 110 may be any polymer film having transparency.

Specifically, the transparent substrate layer 110 may be a film made of a polymer such as a cycloolefin derivative having a cycloolefin-containing monomer such as a norbornene or polycyclic norbornene-based monomer, cellulose (e.g., diacetyl cellulose, triacetyl cellulose, acetyl cellulose butylate, isobutyl ester cellulose, propionyl cellulose, butyryl cellulose or acetylpropionyl cellulose), an ethylene/vinyl acetate copolymer, polycycloolefins, polyester, polystyrene, polyamide, polyetherimide, polyacryl, polyimide, polyethersulfone, polysulfone, polyethylene, polypropylene, polymethylpentene, polyvinyl chloride, polyvinylidene chloride, polyvinyl alcohol, polyvinyl acetal, polyetherketone, polyether ether ketone, polymethyl methacrylate, polyethylene terephthalate, polybutylene terephthalate, polyethylene naphthalate, polycarbonate, polyurethane, epoxy and the like, and may also be an unoriented film or a uniaxially or biaxially oriented film. These polymers may be used alone or in combination of two or more.

A polyimide film and a uniaxially or biaxially oriented polyester film, which have excellent transparency and heat resistance, a cycloolefin derivative film and a polymethyl methacrylate film, which have excellent transparency and heat resistance and are capable of supporting a large-sized film, and triacetyl cellulose and isobutylester cellulose films, which have transparency and do not have optical anisotropy, may be preferably used.

First Hard Coating Layer

The first hard coating layer 120 may be formed by applying a hard coating composition having a high elongation oligomer on one surface of the transparent substrate layer 110 and then photocuring the composition through radiation of ultraviolet rays.

The first hard coating layer 120 preferably has a thickness ranging from 50 to 300 μm. When a thickness of the first hard coating layer 120 is below 50 μm, impact resistance may be degraded. On the other hand, when a thickness of the first hard coating layer 120 is above 300 μm, bending resistance may be degraded and a curl may occur.

Second Hard Coating Layer

The second hard coating layer 130 may be formed by applying a hard coating composition on a top surface of the first hard coating layer 120 and then photocuring the composition through radiation of ultraviolet rays.

The second hard coating layer 130 preferably has a Martens hardness ranging from 350 to 1000 N/mm² and a compressive elastic modulus ranging from 4000 to 10000 MPa. When the second hard coating layer 130 has a Martens hardness and compressive elastic modulus below these ranges, scratch resistance may be degraded.

The second hard coating layer 130 preferably has a thickness ranging from 1 to 20 μm, more preferably, 5 to 10 μm. When a thickness of the second hard coating layer 130 is below these ranges, scratch resistance may be degraded. On the other hand, when a thickness of the second hard coating layer 130 is above these ranges, the layer may be broken or a curl may occur.

The hard coating composition includes a high elongation oligomer and may further include one or more of a photopolymerizable compound, a solvent, a photoinitiator and an additive. This will be described below in more detail.

In this case, a method of applying the hard coating composition may be used without limitation as long as it can be applied in the art. For example, a bar coating method, a knife coating method, a roll coating method, a blade coating method, a die coating method, a micro-gravure coating method, a comma coating method, a slot die coating method, a lip coating method, a solution casting method or the like may be used.

Photopolymerizable Compound

A photopolymerizable compound is used to form the first hard coating layer 120 and the second hard coating layer 130 and may be a photopolymerizable monomer, a photopolymerizable oligomer or the like, all of which include a photopolymerizable functional group. For example, the photopolymerizable compound may be a photo-radical polymerizable compound.

As the photopolymerizable monomer, a monomer used in the art which has a commonly used photocurable functional group, for example, an unsaturated group such as a (meth)acryloyl group, a vinyl group, a styryl group, an allyl group or the like in a molecule, may be used without limitation. More specifically, the photopolymerizable monomer may be, for example, monofunctional and/or multifunctional (meth)acrylate. These may be used alone or in combination of two or more.

The term “(meth)acryl-” used herein is referred to as “methacryl-”, “acryl-” or both.

Specifically, a (meth)acrylate monomer may be, as a (meth)acrylic ester, trimethylolpropane tri(meth)acrylate, pentaerythritol tri(meth)acrylate, glycerol tri(meth)acrylate, tris(2-hydroxyethyl)isocyanurate tri(meth)acrylate, ethylene glycol di(meth)acrylate, propylene glycol (meth)acrylate, 1,3-butanediol di(meth)acrylate, 1,4-butanediol di(meth)acrylate, 1,6-hexanediol di(meth)acrylate, neopentyl glycol di(meth)acrylate, diethylene glycol di(meth)acrylate, triethylene glycol di(meth)acrylate, dipropylene glycol di(meth)acrylate, bis(2-hydroxyethyl)isocyanurate di(meth)acrylate, and ethylene oxide- or propylene oxide-added poly(meth)acrylate; oligoester (meth)acrylate, oligoether (meth)acrylic ester, oligo urethane (meth)acrylic ester, and oligo epoxy (meth)acrylic ester, all of which have 1 to 3 (meth)acryloyl groups in a molecule; hydroxyethyl (meth)acrylate, hydroxypropyl (meth)acrylate, hydroxybutyl (meth)acrylate, and a product produced by adding ethylene oxide or propylene oxide to the (meth)acrylic ester; and mono (meth)acrylic ester, for example, a monomer having a tri or less-functional (meth)acryloyl group such as iso-octyl (meth)acrylate, iso-decyl (meth)acrylate, stearyl (meth)acrylate, tetrahydrofurfuryl (meth)acrylate, phenoxyethyl (meth)acrylate and the like, and dipentaerythritol hexa(meth)acrylate, dipentaerythritolhydroxyl penta(meth)acrylate, pentaerythritol tetra(meth)acrylate, ditrimethylolpropane tetra(meth)acrylate and the like. These may be used alone or in combination of two or more.

The photopolymerizable oligomer may include, for example, one or more selected from the group consisting of epoxy (meth)acrylate, urethane (meth)acrylate, and polyester (meth)acrylate. Preferably, urethane (meth)acrylate and polyester (meth)acrylate may be used in combination or two types of polyester (meth)acrylate may be used in combination. Preferably, a urethane (meth)acrylate oligomer may be used to improve scratch resistance and hardness of a cured product and enhance the elastic moduli of the first hard coating layer 120 and the second hard coating layer 130.

The epoxy (meth)acrylate may be obtained by reacting a carboxylic acid having a (meth)acryloyl group with an epoxy compound. Specifically, the epoxy compound may be glycidyl (meth)acrylate, C1 to C12 linear alcohol-terminated glycidyl ether, diethylene glycol diglycidyl ether, tripropylene glycol diglycidyl ether, bisphenol A diglycidyl ether, ethylene oxide modified bisphenol A diglycidyl ether, propylene oxide modified bisphenol A diglycidyl ether, trimethylolpropane triglycidyl ether, pentaerythritol tetraglycidyl ether, hydrogenated bisphenol A diglycidyl ether, glycerin diglycidyl ether, or the like. The carboxylic acid having a (meth)acryloyl group may be (meth)acrylic acid, 2-(meth)acryloyloxyethyl succinic acid, 2-(meth)acryloyloxyethyl hexahydrophthalic acid, or the like.

The urethane (meth)acrylate may be prepared by reacting a multifunctional (meth)acrylate having a hydroxyl group in a molecule and a compound having an isocyanate group in the presence of a catalyst according to a method known in the art.

The multifunctional (meth)acrylate having a hydroxyl group in a molecule may be one or more selected from the group consisting of 2-hydroxyethyl (meth)acrylate, 2-hydroxyisopropyl (meth)acrylate, 4-hydroxybutyl (meth)acrylate, caprolactone ring-opened hydroxyacrylate, a mixture of pentaerythritol tri- and tetra-(meth)acrylate, and a mixture of dipentaerythritol penta- and hexa-(meth)acrylate.

In addition, the compound having an isocyanate group may be one or more selected from the group consisting of 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexene diisocyanate, 4,4′-methylenebis(cyclohexyl isocyanate), isophorone diisocyanate, toluene-2,4-diisocyanate, toluene-2,6-diisocyanate, xylene-1,4-diisocyanate, tetramethylxylene-1,3-diisocyanate, l-chloromethyl-2,4-diisocyanate, 4,4′-methylenebis(2,6-dimethylphenyl isocyanate), 4,4′-oxybis(phenyl isocyanate), tri-functional isocyanate derived from hexamethylene diisocyanate, and trimethane propanol adduct toluene diisocyanate.

More specifically, the urethane (meth)acrylate oligomer may be a compound including two or more each of a substituent represented by the following Chemical Formula 1 and a (meth)acryloyl group in a molecule.

*—OC(═O)NH—* [Chemical Formula 1]

The urethane (meth)acrylate oligomer may be produced represented by reacting 1 mole of diisocyanate by the following Chemical Formula 2 and 2 moles of an active-hydrogen-containing polymerizable unsaturated compound.

R₁—OC(═O)NH—R₃—NHC(═O)O—R₂ [Chemical Formula 2]

In Chemical Formula 2, R₁ and R₂ are each independently substituents including a (meth)acryloyl group derived from an active-hydrogen-containing polymerizable unsaturated compound, and R₃ is a divalent substituent derived from a diisocyanate.

The urethane (meth)acrylate oligomer may be prepared, for example, by reacting 2-hydroxyethyl (meth)acrylate and 2,4-tolylene diisocyanate, reacting 2-hydroxyethyl (meth)acrylate and isophorone diisocyanate, reacting 2-hydroxybutyl (meth)acrylate and 2,4-tolylene diisocyanate, reacting 2-hydroxybutyl (meth)acrylate and isophorone diisocyanate, reacting pentaerythritol tri(meth)acrylate and 2,4-toluene diisocyanate, reacting pentaerythritol tri(meth)acrylate and isophorone diisocyanate, reacting pentaerythritol tri(meth)acrylate and dicyclohexylmethane diisocyanate, reacting dipentaerythritol penta (meth)acrylate and isophorone diisocyanate, or reacting dipentaerythritol penta(meth)acrylate and dicyclohexylmethane diisocyanate.

The polyester (meth)acrylate may be prepared by reacting a polyester polyol and acrylic acid according to a method known in the art.

The polyester (meth)acrylate may be, for example, one or more selected from the group consisting of polyester acrylate, polyester diacrylate, polyester tetraacrylate, polyester hexaacrylate, polyester pentaerythritol triacrylate, polyester pentaerythritol tetraacrylate, and polyester pentaerythritol hexaacrylate, but the present invention is not limited thereto.

The photopolymerizable monomer and the photopolymerizable oligomer may be used alone or in combination. When the photopolymerizable monomer and the photopolymerizable oligomer are used in combination, it is possible to enhance the workability and compatibility of a composition for forming the hard coating layer.

The content ratio of the photopolymerizable monomer and the photopolymerizable oligomer may be appropriately selected in consideration of storage elastic modulus, a contractile force, workability and the like of the first hard coating layer 120 and the second hard coating layer 130 without specific limitation. For example, the content ratio of the photopolymerizable oligomer with respect to the photopolymerizable monomer may be 1:10 to 10:1. When the content ratio of the polymerizable oligomer with respect to the polymerizable monomer is outside this range, the storage elastic moduli of the first hard coating layer 120 and the second hard coating layer 130 decrease or a contractile force thereof increases. Thus, hardness and flexibility may be degraded and a curl may occur.

A content of the photopolymerizable compound is not specifically limited, but the photopolymerizable compound is preferably included, for example, at a content of 1 to 80 parts by weight, more preferably, 5 to 50 parts by weight with respect to 100 parts by weight of a composition for forming the hard coating layer. When the content of the photopolymerizable compound is below these ranges, the elastic modulus of a coating layer decreases and thus a coating layer may be easily cracked when bent. On the other hand, when the content of the photopolymerizable compound is above these ranges, applicability may be degraded due to an increase in viscosity and an appearance property may be degraded due to insufficient surface leveling.

Further, an inorganic nanofiller may also be used to improve hardness and scratch resistance. As a representative inorganic nanofiller, silica (less than 100 μm) may be used. The silica may have or may not have a photocurable group that can be involved in a surface photoreaction.

High Elongation Oligomer

The hard coating composition according to the present invention includes a high elongation oligomer.

The high elongation oligomer preferably has an elastic modulus ranging from 10 to 3000 MPa and an elongation at break ranging from 30 to 150%. When elastic modulus and elongation at break are within these ranges, it is possible to exhibit excellent bending resistance and impact resistance and minimize the occurrence of a curl.

The high elongation oligomer includes a photocurable (meth)acrylate oligomer.

The photocurable (meth)acrylate oligomer may include one or more selected from the group consisting of epoxy (meth)acrylate, urethane (meth)acrylate, and polyester (meth)acrylate. Preferably, urethane (meth)acrylate and polyester (meth)acrylate are used in combination or both polyester and urethane groups are included in a molecule.

The epoxy (meth)acrylate may be obtained by reacting a carboxylic acid having a (meth)acryloyl group with an epoxy compound. Specifically, the epoxy compound may be glycidyl (meth)acrylate, C1 to C12 linear alcohol-terminated glycidyl ether, diethylene glycol diglycidyl ether, tripropylene glycol diglycidyl ether, bisphenol A diglycidyl ether, ethylene oxide modified bisphenol A diglycidyl ether, propylene oxide modified bisphenol A diglycidyl ether, trimethylolpropane triglycidyl ether, pentaerythritol tetraglycidyl ether, hydrogenated bisphenol A diglycidyl ether, glycerin diglycidyl ether, or the like. The carboxylic acid having a (meth)acryloyl group may be (meth)acrylic acid, 2-(meth)acryloyloxyethyl succinic acid, 2-(meth)acryloyloxyethyl hexahydrophthalic acid, or the like.

The urethane (meth)acrylate may be prepared by reacting a multifunctional (meth)acrylate having a hydroxyl group in a molecule and a compound having an isocyanate group in the presence of a catalyst.

The (meth)acrylate having a hydroxyl group in a molecule may be one or more selected from the group consisting of 2-hydroxyethyl (meth)acrylate, 2-hydroxyisopropyl (meth)acrylate, 4-hydroxybutyl (meth)acrylate, caprolactone ring-opened hydroxyacrylate, a mixture of pentaerythritol tri- and tetra-(meth)acrylate, and a mixture of dipentaerythritol penta- and hexa-(meth)acrylate.

The compound having an isocyanate group in a molecule may be one or more selected from the group consisting of 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexene diisocyanate, 4,4′-methylenebis(cyclohexyl isocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis(2,6-dimethylphenyl isocyanate), 4,4′-oxybis(phenyl isocyanate), tri-functional isocyanate derived from hexamethylene diisocyanate, and trimethane propanol adduct toluene diisocyanate.

The polyester (meth)acrylate may be, specifically, a diacrylate such as ethylene glycol di(meth)acrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, tripropylene glycol di(meth)acrylate, 1,4-butanediol di(meth)acrylate, neopentyl glycol di(meth)acrylate, 1,6-hexanediol di(meth)acrylate, tricyclodecane di(meth)acrylate, bisphenol A di(meth)acrylate, and the like, trimethylolpropane tri(meth)acrylate, pentaerythritol tri(meth)acrylate, pentaerythritol tetra(meth)acrylate, ditrimethylolpropane tetra(meth)acrylate, dipentaerythritol penta(meth)acrylate, dipentaerythritol hexa(meth)acrylate, tris(2-(meth)acryloyloxyethyl)isocyanurate, or the like.

It is preferable that the urethane (meth)acrylate and the polyester (meth)acrylate be used in combination or both polyester and urethane groups be included in one molecule. In particular, an acrylate having a linear structure may be used to form a high elongation coating film having an elongation of 30% or more.

The high elongation oligomer is preferably included at 1 to 90 wt %, more preferably, 5 to 80 wt % with respect to 100 wt % of the entire hard coating composition. When a content of the high elongation oligomer is below these ranges, it is difficult to form a coated film or to manufacture the hard coating film 100 having a sufficient level of impact resistance even when a coated film is formed. On the other hand, when a content thereof is above these ranges, uniformity of a coated film may be degraded due to high viscosity during the manufacture of the hard coating film 100.

Solvent

The solvent is a material that may dissolve or disperse the above-described composition and may be used without limitation as long as it is known as a solvent of a hard coating composition in the art.

Specifically, the solvent may preferably be alcohols (e.g., methanol, ethanol, isopropanol, butanol, methyl cellosolve, ethyl cellosolve, and the like), ketones (e.g., methyl ethyl ketone, methyl butyl ketone, methyl isobutyl ketone, diethyl ketone, dipropylketone, cyclohexanone, and the like), acetates (e.g., ethyl acetate, propyl acetate, n-butyl acetate, t-butyl acetate, methyl cellosolve acetate, ethyl cellosolve acetate, propylene glycol monomethyl ether acetate, propylene glycol monoethyl ether acetate, propylene glycol monopropyl ether acetate, methoxybutyl acetate, methoxypentyl acetate, and the like), an alkane (e.g., hexane, heptane, octane, and the like), benzene or derivatives thereof (e.g., benzene, toluene, xylene, and the like), ethers (e.g., diethylene glycol dimethyl ether, diethylene glycol diethyl ether, diethylene glycol dipropyl ether, diethylene glycol dibutyl ether, propylene glycol monomethyl ether, and the like), or the like. The solvents may be used alone or in combination of two or more.

The solvent is preferably included at 10 to 95 wt % with respect to 100 wt % of the entire hard coating composition. When a content of the solvent is below 10 wt %, not only workability may be degraded by an increase in viscosity but also the swelling of the transparent substrate may not be sufficiently performed. On the other hand, when a content thereof is above 95 wt %, a drying process may take a long time and economic feasibility may decrease.

Photoinitiator

The photoinitiator may be used without limitation as long as it is used in the art and may be one or more selected from the group consisting of a hydroxy ketone, an amino ketone, and a hydrogen-abstraction-type photoinitiator.

Specifically, the photoinitiator may be 2-methyl-1-[4-(methylthio)phenyl]2-morpholine propanone-1, diphenyl ketone, benzyl dimethyl ketal, 2-hydroxy-2-methyl-1-phenyl-1-one, 4-hydroxy cyclophenyl ketone, 2,2-dimethoxy-2-phenyl-acetophenone, anthraquinone, fluorene, triphenylamine, carbazole, 3-methylacetophenone, 4-chloroacetophenone, 4,4-dimethoxyacetophenone, 4,4-diaminobenzophenone, 1-hydroxycyclohexyl phenyl ketone, benzophenone, diphenyl(2,4,6-trimethylbenzoyl)phosphine oxide, or the like. These may be used alone or in combination of two or more.

The photoinitiator is preferably included at 0.1 to 10 wt %, more preferably, 1 to 5 wt % with respect to 100 wt % of the entire hard coating composition. When a content of the photoinitiator is below these ranges, the curing speed of the hard coating composition may decrease and mechanical properties may be degraded due to insufficient curing. On the other hand, when a content thereof is above these ranges, a coated film may be cracked due to overcuring.

Additive

In one exemplary embodiment of the present invention, the coating composition may further include an additive which may include one or more selected from the group consisting of an inorganic nanoparticle, a leveling agent, and a stabilizer.

The inorganic nanoparticles may be selectively added to improve hardness of a hard coating layer. Specifically, when the inorganic nanoparticles are included in the hard coating composition, it is possible to further improve mechanical properties. More specifically, the inorganic nanoparticles are uniformly formed in a coated film and thus it is possible to improve mechanical properties such as wear resistance, scratch resistance, pencil hardness, and the like.

The inorganic nanoparticle may have an average diameter of 1 to 100 nm, particularly 1 to 80 nm, and more particularly 5 to 50 nm. When an average diameter of the inorganic nanoparticle is within these ranges, it is possible to prevent a phenomenon in which agglomeration occurs in a composition and thus form a uniform coated film, and also, to prevent a decrease in optical characteristics and mechanical properties of a coated film.

The inorganic nanoparticle may include one or more selected from the group consisting of Al₂O₃, SiO₂, ZnO, ZrO₂, BaTiO₃, TiO₂, Ta₂O₅, Ti₃O₅, ITO, IZO, ATO, ZnO—Al, Nb₂O₃, SnO, MgO, and a combination thereof, but the present invention is not limited thereto. The inorganic nanoparticle may include a metal oxide commonly used in the art.

Specifically, the inorganic nanoparticle may be Al₂O₃, SiO₂, or ZrO₂. The inorganic nanoparticle may be directly manufactured or may be a commercially available product in which the inorganic nanoparticles are dispersed in an organic solvent at a concentration of 10 to 80 wt %.

The leveling agent may include one or more selected from the group consisting of a silicone-based leveling agent, a fluorine-based leveling agent, and an acrylic leveling agent. When the leveling agent is included in the hard coating composition, it is possible to impart smoothness and coatability during the formation of a coated film.

Specifically, the leveling agent may be BYK-323, BYK-331, BYK-333, BYK-337, BYK-373, BYK-375, BYK-377, or BYK-378, all of which are commercially available from BYK Chemie GmbH, TEGO Glide 410, TEGO Glide 411, TEGO Glide 415, TEGO Glide 420, TEGO Glide 432, TEGO Glide 435, TEGO Glide 440, TEGO Glide 450, TEGO Glide 455, TEGO Rad 2100, TEGO Rad 2200N, TEGO Rad 2250, TEGO Rad 2300, TEGO Rad 2500, all of which are commercially available from Evonik TEGO Chemie GmbH, FC-4430, FC-4432, all of which are commercially available from 3M, or the like, but the present invention is not limited thereto. A leveling agent commonly used in the art may be used.

The stabilizer may include one or more selected from the group consisting of hindered amine; phenyl salicylate; benzophenone; benzotriazole; nickel derivative; radical scavenger; polyphenol; phosphite; and lactone stabilizers.

The term “UV stabilizer” used herein refers to an additive that is added for the purpose of protecting an adhesive by blocking or absorbing UV rays because the cured surface of a coated film is discolored and easily broken due to decomposition caused by continuous UV ray exposure.

The UV stabilizer may be classified as an absorbent, a quencher, or a hindered amine light stabilizer (HALS) based on a mechanism. Also, the UV stabilizer may be classified as phenyl salicylate (absorbent), benzophenone (absorbent), benzotriazole (absorbent), a nickel derivative (quencher), or a radical scavenger based on a chemical structure.

However, the present invention is not specifically limited thereto as long as an UV stabilizer does not significantly change the initial color of an adhesive.

As a heat stabilizer which is a commercially applicable product, polyphenols (a primary heat stabilizer) and phosphites and lactones (a secondary heat stabilizer) may be used alone or in combination thereof. The UV stabilizer and the heat stabilizer may be used by appropriately adjusting a content thereof at a level at which an UV curing property is not affected.

<Image Display Device>

The hard coating film according to the present invention may be a film for a flexible display. Specifically, the hard coating film may be used as a functional layer or a substitute for a cover glass of a display such as a LCD, an OLED, a LED, a FED and the like, a touch panel of various mobile phone, a smart phone or a tablet PC using the display, electronic paper or the like.

The present invention provides an image display device which includes the hard coating film 100.

Also, the present invention provides a window of a flexible display device which includes the hard coating film.

Hereinafter, the present invention will be described in more detail with reference to the exemplary embodiments. However, the exemplary embodiment should be considered in a descriptive sense only, and the present invention is not limited thereto. Therefore, it should be understood that various changes and modifications can be made to the exemplary embodiments without departing from the scope of the present invention by those skilled in the art. Hereinafter, all “percentage(s)” and “part(s)” representing the content are by weight unless otherwise specified.

### Preparation Examples 1 to 6: Preparation of Composition for Hard Coating Layer

### Preparation Example 1

70 parts by weight of urethane acrylate (UA-122P commercially available from Shin-Nakamura Chemical Co., Ltd.), 25 parts by weight of methyl ethyl ketone, 4.5 parts by weight of a photoinitiator (1-Hydroxy-cyclohexyl-phenyl-ketone), and 0.5 parts by weight of a leveling agent (BYK-3570 commercially available from BYK Chemie GmbH) were mixed using a stirrer and filtered using a filter made of polypropylene (PP) to prepare a hard coating composition. Here, the urethane acrylate had an elastic modulus of 2070 MPa and an elongation at break of 58%.

### Preparation Example 2

70 parts by weight of urethane acrylate (UA-232P commercially available from Shin-Nakamura Chemical Co., Ltd.), 25 parts by weight of methyl ethyl ketone, 4.5 parts by weight of a photoinitiator (1-Hydroxy-cyclohexyl-phenyl-ketone), and 0.5 parts by weight of a leveling agent (BYK-3570 commercially available from BYK Chemie GmbH) were mixed using a stirrer and filtered using a filter made of polypropylene (PP) to prepare a hard coating composition. Here, the urethane acrylate had an elastic modulus of 1320 MPa and an elongation at break of 135%.

### Preparation Example 3

70 parts by weight of urethane acrylate (UA-122P commercially available from Shin-Nakamura Chemical Co., Ltd.), 25 parts by weight of methyl ethyl ketone, 4.5 parts by weight of a photoinitiator (1-Hydroxy-cyclohexyl-phenyl-ketone), and 0.5 parts by weight of a leveling agent (BYK-3570 commercially available from BYK Chemie GmbH) were mixed using a stirrer and filtered using a filter made of polypropylene (PP) to prepare a hard coating composition. Here, the urethane acrylate had an elastic modulus of 2570 MPa and an elongation at break of 67%.

### Preparation Example 4

20 parts by weight of pentaerythritol triacrylate, 50 parts by weight of an inorganic nanosilica sol (20 nm silica 40% and methyl ethyl ketone 60%), 25 parts by weight of methyl ethyl ketone, 4.7 parts by weight of a photoinitiator (1-Hydroxy-cyclohexyl-phenyl-ketone), and 0.3 parts by weight of a leveling agent (BYK-3570 commercially available from BYK Chemie GmbH) were mixed using a stirrer and filtered using a filter made of polypropylene (PP) to prepare a hard coating composition. The hard coating composition thus prepared was coated on glass and dry-cured, and then the Martens hardness and compressive elastic modulus of a coated film were measured using a nanoindenter. As a result, a Martens hardness was 835 N/mm² and a compressive elastic modulus was 9120 MPa.

### Preparation Example 5

30 parts by weight of pentaerythritol triacrylate, 40 parts by weight of an inorganic nanosilica sol (silica 40% and methyl ethyl ketone 60%), 25 parts by weight of methyl ethyl ketone, 4.7 parts by weight of a photoinitiator (1-Hydroxy-cyclohexyl-phenyl-ketone), and 0.3 parts by weight of a leveling agent (BYK-3570 commercially available from BYK Chemie GmbH) were mixed using a stirrer and filtered using a filter made of polypropylene (PP) to prepare a hard coating composition. The hard coating composition thus prepared was coated on glass and dry-cured, and then Martens hardness and compressive elastic modulus of a coated film were measured using a nanoindenter. As a result, a Martens hardness was 785 N/mm² and a compressive elastic modulus was 8830 MPa.

### Preparation Example 6

15 parts by weight of pentaerythritol triacrylate, 15 parts by weight of an ethylene-oxide-containing tetra-functional acrylate (Miramer M4004 commercially available from Miwon Specialty Chemical Co., Ltd.), 40 parts by weight of an inorganic nanosilica sol (silica 40% and methyl ethyl ketone 60%), 25 parts by weight of methyl ethyl ketone, 4.7 parts by weight of a photoinitiator (1-Hydroxy-cyclohexyl-phenyl-ketone), and 0.3 parts by weight of a leveling agent (BYK-3570 commercially available from BYK Chemie GmbH) were mixed using a stirrer and filtered using a filter made of polypropylene (PP) to prepare a hard coating composition. The hard coating composition thus prepared was coated on glass and dry-cured, and then Martens hardness and compressive elastic modulus of a coated film were measured using a nanoindenter. As a result, a Martens hardness was 399 N/mm² and a compressive elastic modulus was 4970 MPa.

### Examples 1 to 9 and Comparative Examples 1 and 2: Manufacture of Hard Coating Film

### Example 1

The hard coating composition prepared in Preparation Example 1 was coated on a polyimide film having a thickness of 80 μm in such a way that the composition has a thickness of 200 μm after curing. After coating the film, the solvent was dried and UV rays were radiated at an integrated light intensity of 500 mJ/cm² for curing the composition to manufacture a first hard coating layer. Next, the hard coating composition prepared in Preparation Example 4 was coated on a top surface of the first hard coating layer so as to have a thickness of 5 μm. After coating the film, the solvent was dried and UVW rays were radiated at an integrated light intensity of 500 mJ/cm² for curing the composition to manufacture a second hard coating layer, and thereby a hard coating film was manufactured.

### Example 2

A hard coating film was manufactured in the same manner as in Example 1 except that the hard coating composition prepared in Preparation Example 5 was used for a second hard coating layer.

### Example 3

A hard coating film was manufactured in the same manner as in Example 1 except that the hard coating composition prepared in Preparation Example 6 was used for a second hard coating layer.

### Example 4

A hard coating film was manufactured in the same manner as in Example 1 except that the hard coating composition prepared in Preparation Example 2 was used for a first hard coating layer.

### Example 5

A hard coating film was manufactured in the same manner as in Example 2 except that the hard coating composition prepared in Preparation Example 2 was used for a first hard coating layer.

### Example 6

A hard coating film was manufactured in the same manner as in Example 3 except that the hard coating composition prepared in Preparation Example 2 was used for a first hard coating layer.

### Example 7

A hard coating film was manufactured in the same manner as in Example 1 except that the hard coating composition prepared in Preparation Example 3 was used for a first hard coating layer.

### Example 8

A hard coating film was manufactured in the same manner as in Example 2 except that the hard coating composition prepared in Preparation Example 3 was used for a first hard coating layer.

### Example 9

A hard coating film was manufactured in the same manner as in Example 3 except that the hard coating composition prepared in Preparation Example 3 was used for a first hard coating layer.

### Comparative Example 1

A hard coating film was manufactured in the same manner as in Example 1 except that a first hard coating composition prepared in Preparation Example 1 was not applied and a second hard coating composition prepared in Preparation Example 4 was coated on one surface of a polyimide film, then dried, and subjected to UV curing so as to have a thickness of 5 μm after curing.

### Comparative Example 2

A hard coating film was manufactured in the same manner as in Example 1 except that only a first hard coating composition prepared in Preparation Example 1 was coated on one surface of a film, dried, and then subjected to UV curing so that the applied first hard coating composition had a thickness of 200 μm after curing.

### Experimental Example

Properties of the hard coating films prepared in Examples 1 to 9 and Comparative Examples 1 and 2 were measured in the following manner, results of which are shown in Table 1. A measurement method and an evaluation method used in the present invention are as follows:

1. Evaluation of Bending Resistance at Room Temperature

A second hard coating layer is directed to face inward, and a hard coating film was folded in half to have an interval of 6 mm between surfaces thereof. Afterward, whether or not a folded portion was cracked when the film was unfolded again was observed by the naked eye and determined, results of which are shown in the following Table 1.

Good: no cracking at folded portion

Failure: cracking at folded portion

2. Impact Resistance

The opposite surface of a hard coating film, that is, a transparent substrate layer, was adhered to glass using a 50 μm optically clear adhesive (OCA) (elastic modulus of 0.08 MPa). Afterward, the maximum weight of the steel ball that did not break the glass below the hard coating film when a steel ball was dropped on the surface of the hard coating layer from a height of 50 cm was measured, results of which are shown in the following Table 1.

3. Scratch Resistance

The opposite surface of a hard coating film, that is, a transparent substrate layer, was adhered to glass using a 25 μm acrylic adhesive. The surface of the hard coating layer was then subjected to a scratch test using steel wool #0000 at a load of 1 kg/cm², in which the steel wool was moved back and forth ten times. Afterward, the number of scratches was determined through visual inspection.

⊚: equal to or less than 10 scratches

◯: equal to or less than 20 scratches

Δ: equal to or less than 30 scratches

X: greater than 30 scratches

4. Curl

A hard coating film was cut to a size of 10 cm×10 cm and maintained under conditions of 25° C. and 48 RH % for 24 hours. Afterward, a degree at which each edge was lifted from the bottom was evaluated, results of which are shown in the following Table 1.

⊚: An average height of four edges is 20 mm or less

◯: An average height of four edges is 50 mm or less

Δ: An average height of four edges is greater than 50 mm

X: Four edges are completely lifted and thus a film is rolled up in a cylindrical form

TABLE 1

| | Bending | | | |
|---|---|---|---|---|
| | resistance | | | |
| | at room | Impact | Scratch | |
| | temperature | resistance | resistance | Curl |
| Example 1 | Good | 40 g | ⊚ | ⊚ |
| Example 2 | Good | 40 g | ⊚ | ⊚ |
| Example 3 | Good | 45 g | ◯ | ⊚ |
| Example 4 | Good | 55 g | ⊚ | ⊚ |
| Example 5 | Good | 55 g | ⊚ | ⊚ |
| Example 6 | Good | 55 g | ◯ | ⊚ |
| Example 7 | Good | 45 g | ⊚ | ⊚ |
| Example 8 | Good | 45 g | ⊚ | ⊚ |
| Example 9 | Good | 45 g | ◯ | ⊚ |
| Comparative | Good | 5 g | ⊚ | ◯ |
| Example 1 | | | | |
| Comparative | Good | 40 g | X | ⊚ |
| Example 2 | | | | |

Referring to Table 1, it can be seen that excellent bending resistance at room temperature, impact resistance and scratch resistance are exhibited and the occurrence of a curl can be minimized in Examples 1 to 9 according to the present invention.

On the other hand, it can be seen that poor impact resistance of 5 g is exhibited in Comparative Example 1, and poor scratch resistance is exhibited in Comparative Example 2.

### LIST OF REFERENCE NUMERALS

100: hard coating film
110: transparent substrate layer
120: first hard coating layer
130: second hard coating layer

What is claimed is:

1. A hard coating film, comprising:
a transparent substrate layer;
a first hard coating layer formed of a cured product of a hard coating composition including a high elongation oligomer having an elastic modulus ranging from 10 to 3000 MPa and an elongation at break ranging from 30 to 150%, and formed on one surface of the transparent substrate layer; and
a second hard coating layer formed on a top surface of the first hard coating layer and having a Martens hardness ranging from 350 to 1000 N/mm² and a compressive elastic modulus ranging from 4000 to 10000 MPa.

2. The hard coating film according to claim 1, wherein the hard coating composition further includes one or more of a photopolymerizable compound, a solvent, a photoinitiator and an additive.

3. The hard coating film according to claim 1, wherein the high elongation oligomer includes a photocurable (meth)acrylate oligomer.

4. The hard coating film according to claim 3, wherein the photocurable (meth)acrylate oligomer is one or more selected from the group consisting of epoxy (meth)acrylate, urethane (meth)acrylate, polyester (meth)acrylate and (meth)acrylate having a urethane group and a polyester group.

5. The hard coating film according to claim 1, wherein the first hard coating layer has a thickness ranging from 50 to 300 μm.

6. The hard coating film according to claim 1, wherein the second hard coating layer has a thickness ranging from 1 to 20 μm.

7. The hard coating film according to claim 1, wherein the high elongation oligomer is included at 1 to 90 wt % with respect to 100 wt % of the entire hard coating composition.

8. A window comprising the hard coating film according to claim 1.

9. An image display device comprising the window according to claim 8.
